(19) United States
(12) Patent Application Publication
(10) Pub. No.: US 2018/0136953 A1
(43) Pub. Date: May 17, 2018

(54) SYSTEM FOR DEFINING A USER INTERFACE OF A REMOTE DISPLAY DEVICE

(71) Applicant: Honeywell International Inc., Morris Plains, NJ (US)

(72) Inventors: Gerald Walter, Canton, OH (US); Joseph Steven Majewski, Strongsville, OH (US)

(21) Appl. No.: 15/145,744

(22) Filed: May 3, 2016

Related U.S. Application Data
(63) Continuation of application No. 12/411,193, filed on Mar. 25, 2009, now abandoned.

(51) Int. Cl. G06F 9/451

(52) U.S. Cl. CPC G06F 9/451

(57) ABSTRACT

An approach for defining user interface components within a building control or automation system. The user interface definition may be rendered on a remote display device. The rendering may be accomplished through a making of a set of object types which represent the components of the user interface. The approach or mechanism should have no dependency on either the hardware/software platform of the building control or automation system or the hardware/software platform of the remote display device.

This application is a continuation of U.S. patent application Ser. No. 12/411,193, filed Mar. 25, 2009, and entitled “A SYSTEM FOR DEFINING A USER INTERFACE OF A REMOTE DISPLAY DEVICE”. U.S. patent application Ser. No. 12/411,193, filed Mar. 25, 2009, is hereby incorporated by reference.

Related patent applications include U.S. patent application Ser. No. 12/411,165, filed Mar. 25, 2009, entitled “MECHANISM FOR INTERFACING A DISPLAY SCREEN OF ANOTHER TECHNOLOGY WITH A COMPUTING PLATFORM”; U.S. patent application Ser. No. 12/411,183, filed Mar. 25, 2009, entitled, “A SMALL SCREEN DISPLAY WITH A DATA FILTERING AND SORTING USER INTERFACE”; U.S. patent application Ser. No. 12/411,201, filed Mar. 25, 2009, entitled “An APPROACH FOR ADVANCED USER NAVIGATION”; U.S. patent application Ser. No. 12/411,134, filed Mar. 25, 2009, entitled “AN AUTOMATIC CONFIGURATOR OF DISPLAY OBJECTS”; U.S. patent application Ser. No. 12/411,080, filed Mar. 25, 2009, entitled “AN EMBEDDED COMPUTING SYSTEM USER INTERFACE EMULATED ON A SEPARATE COMPUTING DEVICE”; all of which are hereby incorporated by reference.

### BACKGROUND

The invention pertains to user interfaces and particularly to user interfaces for displays.

### SUMMARY

The invention is a system for defining a user interface of a remote display device.

### BRIEF DESCRIPTION OF THE DRAWING

FIG. 1a is a diagram of a layout of a Niagara system, a heterogeneous display device and an interconnecting communications driver;

FIG. 1b is a diagram of a screen navigation hierarchy;

FIG. 2 is a diagram of an object types hierarchy;

FIG. 3a shows a screen of a user interface definition in a computing platform;

FIG. 3b shows a screen of a user interface definition in a computing platform like that of FIG. 3a but with additional detail;

FIG. 4 is an illustrative example of a home page;

FIG. 5 is a diagram of an illustrative HVAC zones screen;

FIG. 6 is a diagram of a screen illustrating a data list and data item;

FIG. 7 is a diagram of a screen showing a cool setpoint with up and down buttons for adjustment;

FIG. 8a is a diagram for defining a screen layout;

FIG. 8b is a diagram for defining a home screen;

FIG. 8c is a diagram for defining a data bar;

FIG. 8d is a diagram for defining a navigation link button;

FIG. 8e is a diagram for defining a navigation node button;

FIG. 8f is a diagram for defining a navigation list;

FIG. 8g is a diagram for defining a navigation list link button;

FIG. 8h is a diagram for defining a navigation list node button;

FIG. 8i is a diagram for defining a data list;

FIG. 8j is a diagram for defining an alarm list; and

FIG. 8k is a diagram for selecting a data item.

### DESCRIPTION

There appears to be a need for a remote display device with a configurable user interface. The remote display may be regarded as a much needed enhancement to a Novar™ building control system platform called Opus™.

The invention is an approach or mechanism for defining the user interface components (i.e., screen layout, screen content, navigation hierarchy) within the building control system. It may be a rendering of that user interface definition on the remote display device. This may be accomplished through the creation of a set of object types. These object types may represent the components of the user interface. A feature of the invention may be that the mechanism has no dependency on either the hardware/software platform of the building control system or the hardware/software platform of the remote display device.

A technical challenge is to develop a dynamically configurable user interface (“UI”) for the remote display device (“display”) of a computing platform (“computer”). In summary, a solution may include an approach for defining the screen layout, the screen content and the navigation hierarchy. This may be achieved through the creation of a set of object types. These object types may represent the components of the user interface. Each object type may have a default look and behavior within the display. An object type may be composed of properties which modify, enhance or extend the object's default look and behavior.

The present approach may utilize the “Extensible Markup Language” (XML). XML may be a general purpose specification for sharing structured data. XML may provide a common format in which the computer and the display can share information. Each object type may be encoded in a XML document using a standardized nomenclature.

The user interface may be composed of screens, screen elements, navigation elements, and data elements. An object type may be defined to represent each of these elements. The user may create the user interface by selecting elements from the available set of object types. The object types selected and their placement within the user interface may define a navigation hierarchy, while the functionality of the object types may define the look and behavior of the user interface.

As components are added to the user interface, the user can modify the look and behavior by editing the components' properties. The user interface definition may then be encoded in XML using the standardized nomenclature and transferred to the display.

Within the display, the user interface definition may be interpreted according to the standardized nomenclature and the components rendered in a manner suitable to the capabilities of the display platform. As the user interface definition is interpreted, modifications of the default behavior may or may not be implemented. This will be dependent upon the capabilities of the display platform (possible constraints may include display screen size, display screen resolution, color versus grayscale, memory, CPU speed, and so forth).

In one approach, the set of object types may include the following items. Screens may include home, navigation list, data list and alarm list object types. The home screen may be an entry point for the user interface and a container for NavLinkButton (navigation link button), NavNodeButton (navigation node button) and DataBar (data bar) objects. The NavigationList (navigation list) screen may be used in defining the hierarchy of the information being presented, and be a container for a list of NavListLinkButton (navigation list link button) and NavListNodeButton (navigation list node button) objects. The DataList (data list) screen may be used to display a list of data values from the computer and the contents may be selected from the available DataItem (data item) object types. The AlarmList (alarm list) screen may display real-time alarm events received from the computer.

Each screen type may have a pre-defined behavior when rendered on the display. Each screen type object may have a “title” property which may be rendered by the display.

Buttons added to the Home screen type may have a pre-defined ordering mechanism. This ordering mechanism may be modified by the implementation of positioning (or coordinate) properties of the button object types. Buttons added to the NavigationList screen type may have a pre-defined ordering mechanism. DataItem object types added to the DataList screen type may have a pre-defined ordering mechanism. Each DataItem object type, when added to the DataList screen, may have a pre-defined behavior.

General navigation elements may include a NavLinkButton and a NavNodeButton. A NavLinkButton may create a navigable link to any screen object in the user interface hierarchy. It may be capable of displaying a user-assigned object name and user-selected image. A NavNodeButton may create a navigable link to a Screen object which exists as a child of the button. It may be capable of displaying a user-assigned object name and user-selected image. These button types may have a pre-defined look or appearance when rendered on the display. The look of these buttons may be modified by the assignment of a unique object name and by the selection of an image. These button types may also have a pre-defined behavior. When these buttons are pressed, the display may navigate to the linked screen. Additional modifiable properties of the buttons may include height and width (size), and horizontal and vertical (or x, y) placement (i.e., location) on a screen (for display).

Home screen elements may include a data bar, a data bar item and a data bar clock. The DataBar may be a user interface element which may contain DataBarItem and DataBarClock objects. The DataBarItem may be a placeholder for a data value from the computer, and content selected from the available DataItem types. It may be capable of displaying a user-assigned name and user-selected image. The DataBarClock may be a placeholder for the current time.

The DataBar may have a pre-defined look when rendered on the display. This look may be modified by properties including orientation (i.e., horizontal and vertical), and location (i.e., top, bottom, left and right). The DataBarItem may have pre-defined behavior. The value of the selected DataItem type may be rendered using that DataItems' modifiers (or facets) which include precision, units of measure, true and false text value, and enumeration range. The DataBarItem look may be modified by assignment of a unique object name and the selection of an image.

Navigation list elements may include a navlistlink button and navlistnode button. The NavListLinkButton may be used in defining the hierarchy of the information being presented (for display); create a navigable link to any Screen object in the user interface hierarchy; be capable of displaying a user-assigned name and a single selection from the available DataItem types. The NavListNodeButton may be used in defining the hierarchy of the information being presented (for a display). It may create a navigable link to a screen object which exists as a child of the button. It may be capable of displaying a user-assigned name and a single selection from the available DataItem types.

These button types may have a pre-defined look when rendered on the display. These button types may also have pre-defined behavior. The value of the selected DataItem object may be rendered using the DataItems' modifiers (or facets) which include precision, units of measure, true and false text value, and enumeration range.

Data items may include objects which represent the primitive data types available in most computers. These objects may be Boolean, Integer, Long, Double, Float, Enum and String. One may note that there may be objects which represent unique data types available in the NiagaraAX Framework. While present in the first approach of the invention, these objects are particular to this approach and would not be part of a generic description of the present system. Such objects may include BooleanPoint, NumericPoint, EnumPoint and StringPoint.

DataItem object types may provide an interface for transferring real-time data between the computer and the display. When a DataItem is added to the user interface definition, it may be associated (or linked) with a data source of a compatible type on the computer. A pre-defined behavior of each DataItem type may be to adopt the modifiers (or facets) of the data source. These modifiers may include precision, units of measure, true and false text values, and enumeration range.

When added to DataBarItem, NavListLinkButton and NavListNodeButton object types, the DataItem interface may allow the value displayed on the DataBarItem, NavListLinkButton and NavListNodeButton, to be updated in real time.

When added to the DataList screen type, each DataItem type may have several pre-defined behaviors as indicated as follows. First, the DataItem may be rendered as a button. This button may display the name assigned to the DataItem when it was added to the user interface and the value of the DataItems' associated (or linked) data source. Second, the DataItem interface may allow the value displayed on the button to be updated in real time. Third, the DataItem interface may allow the data source to be modified in real time if the data source is in a writeable state. Fourth, the DataItem may adopt the readonly or writeable state of the data source with which it has been associated (or linked). This state may influence the look and behavior of the button. If the data source is readonly, the button may have a grayed-out appearance to indicate that the DataList entry is inactive and available only for viewing. If the data source is writeable, the button may have a normal appearance indicating that the DataList entry is active and available for editing. Fifth, the DataItem object type may have an associated editing screen. This screen may be rendered on the display if the button is active and pressed by the display user. Editing screens may be provided for modifying the value of numeric-type DataItems, the true/false state of boolean-type DataItems, the ordinal of enumeration-type DataItems, or the text of string-type DataItems. Sixth, if no editing screen is implemented for a particular DataItem type, any button on any DataList for that DataItem type may appear inactive regardless of the data source's readonly or writeable state.

The following listing is an XML Representation of a user interface definition.

<p n=″screenLayout″ h=″12b0a″ t=″LayoutContainer>
<p n=″navigationButtons″ h=″12b0b″ t=″NavigationButtons″>
<p n=″home″ v=″House.png″/>
<p n=″leftArrow″ v=″LeftGreenArrow.png″/>
<p n=″rightArrow″ v=″RightGreenArrow.png″/>
<p n=″upArrow″ v=″UpArrow.png″/>
<p n=″downArrow″ v=″DownArrow.png″/>
<p n=″back″ v=″UpFolder.png″/>
<p n=″ok″ v=″Checkmark.png″/>
<p n=″cancel″ v=″Cancel.png″/>
<p n=″connected″ v=″Connected-15x15.png″/>
<p n=″disconnected″ v=″Disconnected-15x15.png″/>
<p n=″unitConfig″ v=″LightBulb.png″/>
</p>
<p n=″home″ h=″12b0c″ t=″HomeScreen″>
<p n=″navigationLink″ v=″12b0c″/>
<p n=″title″ v=″Home″/>
<p n=″DataBar″ h=″12b70″ t=″DataBar″>
<p n=″Temperature″ h=″12b71″ t=″DataBarItem″>
<p n=″imageFile″ v=″Thermometer.png″/>
<p n=″Outdoor$20Temp″ h=″12b72″ t=″PointValueNumeric″>
<p n=″facets″ v=″units=&#xba;F,precision=1,min=20,max=170″/>
<p n=″out″ t=″StatusNumeric″ v=″60.955014790634024″ s=″88″/>
</p>
</p>
<p n=″Humidity″ h=″132c3″ t=″DataBarItem″>
<p n=″Humidity$20Sensor″ h=″132c4″ t=″PointValueNumeric″>
<p n=″facets″ v=″units=%RH,precision=1,min=0,max=100″/>
<p n=″out″ t=″StatusNumeric″ v=″30.23257561015398″ s=″0″/>
</p>
</p>
<p n=″TimeOfDay″ h=″12b73″ t=″DataBarClock″>
</p>
</p>
<p n=″HVAC″ h=″12b76″ t=″NavNodeButton″>
<p n=″imageFile″ v=″HVAC.png″/>
<p n=″HVAC$20Zones″ h=″12b77″ t=″NavListScreen″>
<p n=″navigationLink″ v=″12b77″/>
<p n=″title″ v=″HVAC Zones″/>
<p n=″$31st$20Floor″ h=″132c7″ s=″0″ t=″NavListNodeButton″>
<p n=″$31st$20Floor″ h=″132c8″ t=″NavListScreen″>
<p n=″navigationLink″ v=″132c8″/>
<p n=″title″ v=″1st Floor″/>
<p n=″Settings″ h=″132c9″ s=″0″ t=″NavListNodeButton″>
<p n=″Settings″ h=″132ca″ t=″DataListScreen″>
<p n=″navigationLink″ v=″132ca″/>
<p n=″title″ v=″1st Floor Settings″/>
<p n=″Cool$20setpoint″ h=″132cb″ t=″ValueInteger″>
<p n=″facets″ v=″units=&#xba;F,min=71,max=127,radix=10″/>
<p n=″out″ t=″StatusNumeric″ v=″787>
</p>
<p n=″Cool$20Mode″ h=″132cc″ t=″ValueBoolean″>
<p n=″facets″ v=″trueText=Active,falseText=Inactive″/>
<p n=″out″ t=″StatusBoolean″ v=″false″/>
</p>
</p>
</p>
<p n=″Monitoring″ h=″132cd″ s=″8″ t=″NavListNodeButton″>
<p n=″Monitoring″ h=″132ce″ t=″DataListScreen″>
<p n=″navigationLink″ v=″132ce″/>
<p n=″title″ v=″1st Floor Monitoring″/>
<p n=″Zone$20Temperatrue″ h=″132cf″ t=″PointValueNumeric″>
<p n=″facets″ v=″units=&#xba;F,precision=1,min=20,max=170″/>
<p n=″out″ t=″StatusNumeric″ v=″60.955014790634024″ s=″88″/>
</p>
<p n=″Damper$20Status″ h=″132d1″ t=″ValueEnum″>
<p n=″facets″ v=″range={Economizer=1,Ventilation=2}″/>
<p n=″out″ t=″StatusEnum″ v=″2″/>
</p>
</p>
</p>
</p>
.</p>
<p n=″$32nd$20Floor″ h=″13043″ s=″0″ t=″NavListNodeButton″>
</p>
</p>
</p>
<p n=″Lighting″ h=″132d2″ t=″NavNodeButton″>
<p n=″imageFile″ v=″LightBulb.png″/>
<p n=″Lighting$20Zones″ h=″132d3″ t=″NavListScreen″>
<p n=″navigationLink″ v=″132d3″/>
<p n=″title″ v=″Lighting Zones″/>
<p n=″Parking$20Lot$20Lights″ h=″132d4″ s=″0″ t=″NavListNodeButton″>
</p>
<p n=″Garden$20Center″ h=″132d5″ s=″0″ t=″NavListNodeButton″>
</p>
</p>
</p>
<p n=″Alarms″ h=″12b74″ t=″NavNodeButton″>
<p n=″imageFile″ v=″Alarm-54x54.png″/>
<p n=″Alerts″ h=″12b75″ t=″AlarmListScreen″>
<p n=″navigationLink″ v=″12b75″/>
<p n=″title″ v=″Alerts″/>
</p>
</p>
</p>
</p>

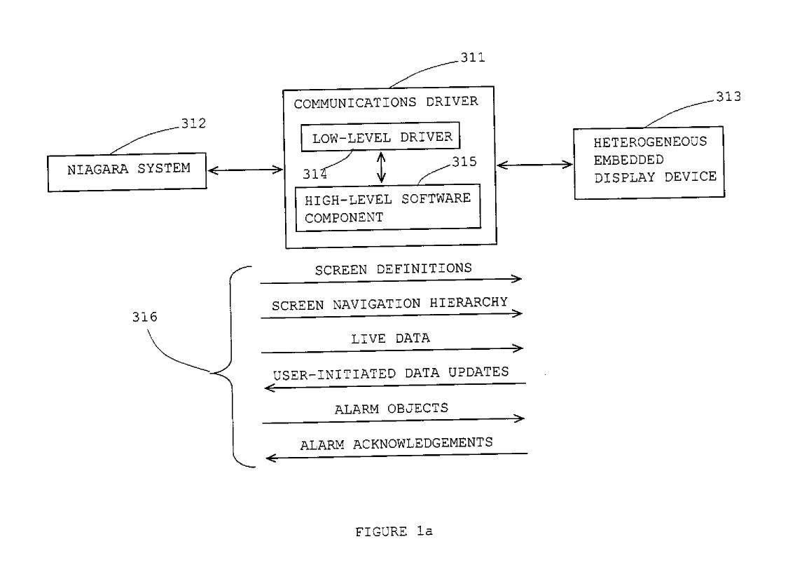

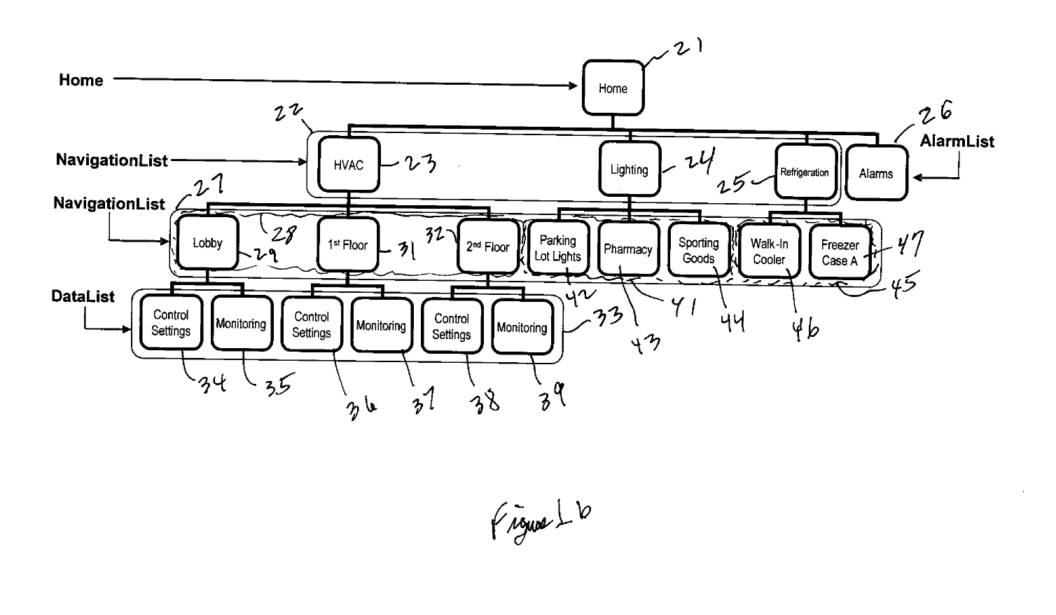

Elements of the invention may involve the NiagaraAX domain. These may be provided by the NiagaraAX-side components. The NiagaraAX components are resident in a so-called NiagaraAX device driver. The components consist of display and navigation definition elements and also a communications driver 311 that transfers information between the NiagaraAX system 312 and the heterogeneous embedded display device 313, as shown in FIG. 1a.

The communications device driver 311 is responsible for transfer of data between the NiagaraAX system 312 and the embedded display device 313. The driver 311 consists of several parts. One is a low-level driver 314 for transferring packets over the communications link with software resident on both the NiagaraAX system 312 and the embedded display 313. Another is a high-level software component 315 to read and write NiagaraAX objects including data points, alarms and screen definitions/navigation information to/from the low-level driver 314.

The following transfers 316 may be performed between the embedded display 313 and the NiagaraAX system 312. The transfers 316 may include screen definitions from NiagaraAX to the display, screen navigation hierarchy from NiagaraAX to the display, live data from NiagaraAX to the display, user-initiated data updates from the display to NiagaraAX, alarm objects from NiagaraAX to the display, and alarm acknowledgements from the display to NiagaraAX.

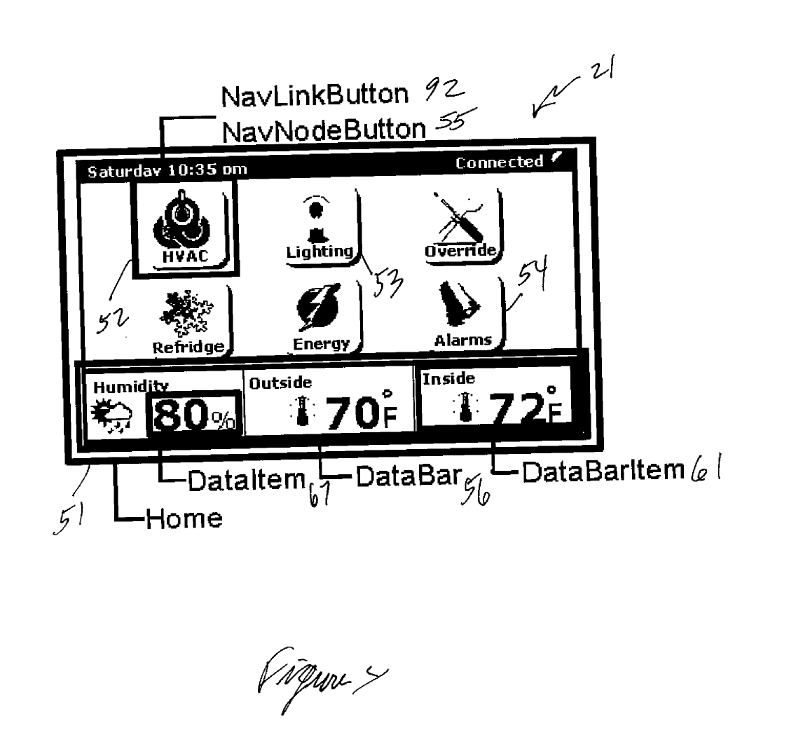

FIG. 1b is a diagram of a screen navigation hierarchy. One may begin with a home page 21 which displays a navigation list 22 having components including heating, ventilation and air condition (HVAC) 23, lighting 24 and refrigeration 25. Also, home page 21 may include an alarm list 26. An example of home page 21 is shown in FIG. 4. From the navigation list 22, one may go to a navigation list 27 at a higher level of detail. From the HVAC 23, which may be a button that is pressed, one can go to a page 28 listing a lobby 29, first floor 31 and second floor 32. These may be buttons. From navigation list 27, particularly the items of page 28, one may go to a data list 33, which may show a higher level of detail than navigation list 27. For example, items of control settings 34 and monitoring 35 may be shown upon pressing a button indicating lobby 29. Items of control settings 36 and monitoring 37 may be shown upon pressing a button indicating first floor 31. Items of control settings 38 and monitoring 39 may be shown upon pressing a button indicating second floor 32.

Pressing a button for lighting component 24 of navigation list 22 may result in navigation list 27 with a page 41 having items of parking lot lights 42, pharmacy 43 and sporting goods 44. Pressing a button for refrigeration 25 may result in navigation list 27 with a page 45 having items of walk-in cooler 46 and freezer case A 47.

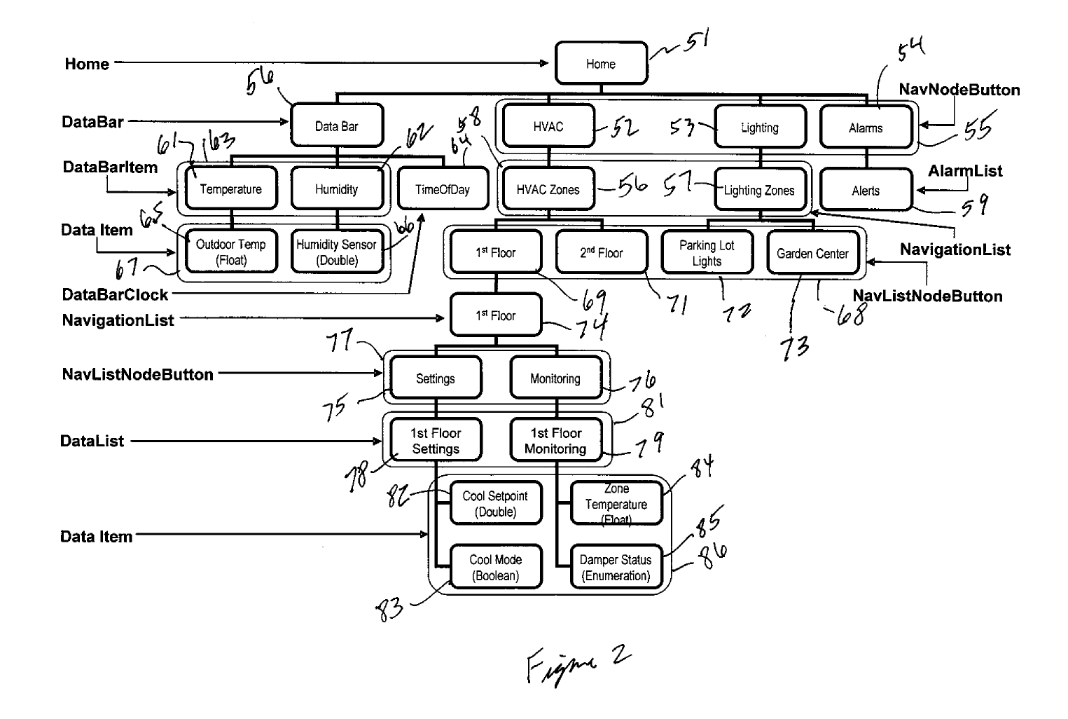

FIG. 2 is a diagram of an object types hierarchy. Object types may represent components of the user interface. There may be a home 51 in which a component button may be activated. There may be HVAC 52, lighting 53 and alarms 54 buttons of type NavNodeButton 55 following from home 51. Also, there may be a data bar 56.

From component HVAC 52 may follow HVAC zones 56. Lighting zones 57 may follow lighting 53. HVAC zones 56 and lighting zones 57 are of type NavigationList 58. Alerts 59 may follow from alarms 54. Alerts 59 may be of type AlarmList.

From data bar 56 may follow temperature 61 and humidity 62. Temperature 61 and humidity 62 may be of type DataBarItem 63. A DataBarClock object type named time of day 64 may also follow from data bar 56. A DataItem 67 object type named outdoor temp (float) 65 may follow from temperature 61 and a DataItem 67 type named humidity sensor (double) 66 may follow from humidity 62.

Objects of type NavListNodeButton 68 may include 1st floor 69, and 2nd floor 71 following from HVAC zones 56. NavListNodeButton 68 type objects parking lot lights 72 and garden center 73 may follow from lighting zones 57.

From 1st floor 69 may be a 1st floor 74 of type NavigationList. Settings 75 and monitoring 76 may be from 1st floor 74 and be of type NavListNodeButton 77. From settings 75 may be DataList 81 type object 1st floor settings 78 and from monitoring 76 may be DataList 81 type object 1st floor monitoring 79. A cool setpoint (double) 82 and a cool mode (boolean) 83 may be from 1st floor settings 78. A zone temperature (float) 84 and damper status (enumeration) 85 may be from 1st floor monitoring 79. Cool setpoint (double) 82, cool mode (boolean) 83, zone temperature (float) 84 and damper status (enumeration) 85 are all DataItem 86 type objects.

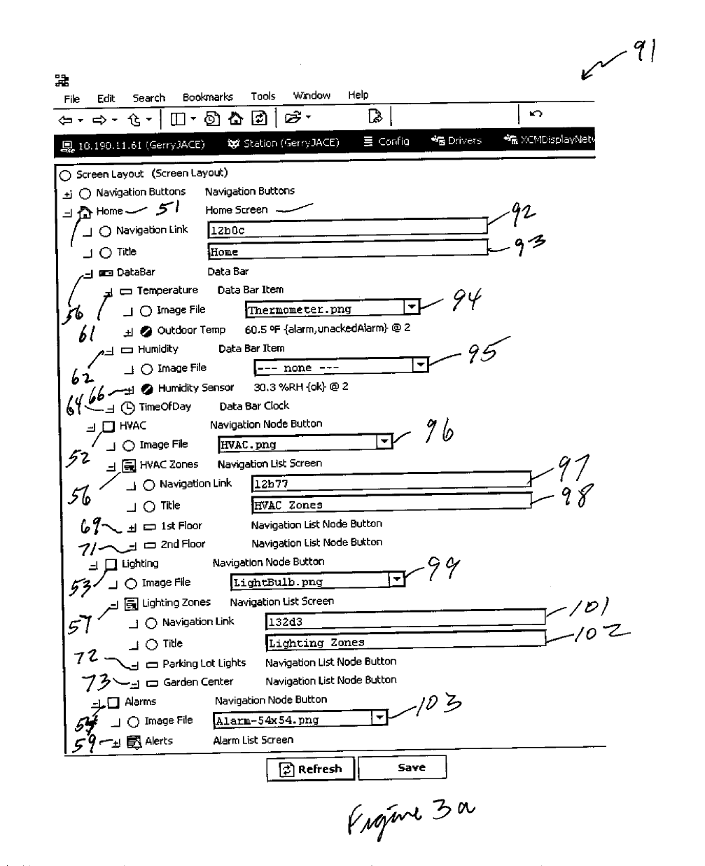

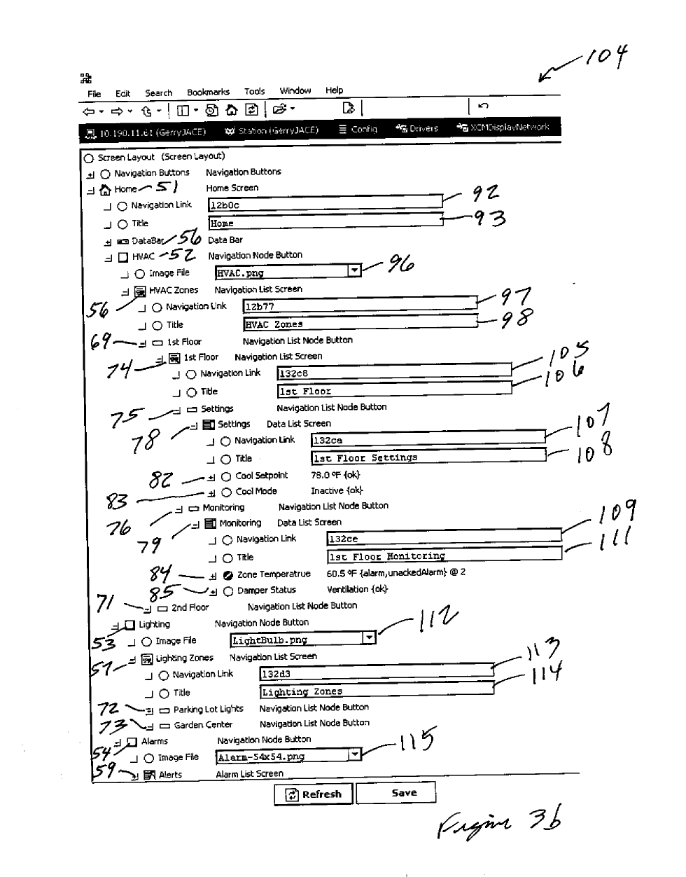

FIG. 3a shows a screen 91 of a user interface definition in a computing platform. The screen 91 shows a tree of the various items in a screen layout. The navigation buttons and home 51 screen are shown with the navigation link 92 and title 93. There may be some correlation of FIG. 3a to FIG. 2 with some items in terms of designation numbers. There is a data bar having a temperature 61 with an image file 94 “Thermometer.png.” Also part of data bar is the humidity 62 with an image file 94 of “none.”

Also part of home 51 is HVAC 52 having an image file 96 of “HVAC.png”, and HVAC zones 56. HVAC zones 56 may have a navigation link 97, a title 98, 1st floor 69 and 2nd floor 71. Also part of home 51 is lighting 53 with image file entitled “LightBulb.png” and lighting zones 57. Lighting zones 57 may include navigation link 101, title 102, parking lot lights 72 and garden center 73. Also part of home 51 is alarms 54 with image file 103 and alerts 59.

FIG. 3b shows a screen 104 of a user interface definition in a computing platform like that of FIG. 3a but with additional detail. Navigation buttons and home 51 are shown with navigation link 92 and title 93. There is also a data bar 56 and HVAC 52. HVAC 52 has image file 96 and HVAC zones 56. HVAC zones 56 may have navigation link 97, title 98 and first floor 69. First floor 69 has first floor 74, navigation link 105, title 106 and settings 75. Settings 75 may have settings 78 and monitoring 76. Settings 78 has a navigation link 107, title 108, cool setpoint 82 and cool mode 83. Monitoring 76 has monitoring 79, which in turn has a navigation link 109, a title 111, zone temperature 84 and damper status 85. Also of HVAC zones 56 is a 2nd floor 71.

Home 51 may also include lighting 53 which in turn includes image file 112 and lighting zones 57. Lighting zones may include navigation link 113, title 114, parking lot lights 72 and garden center 73. Home 51 may also include alarms 54. An image file 115 and alerts 59 may be included in alarms 54.

FIGS. 3a and 3b are illustrative examples of user interface definition in a computing platform. User interface may be significantly more detailed than the present examples.

FIGS. 4, 5, 6 and 7 show a series of screens with increasing detail, respectively. FIG. 4 shows a home screen rendered on a remote display device. It is a diagram of an example home screen 21 of home 51. A nav link button 92 and a nav node button 58 may be associated with obtaining home screen 21. Shown are an HVAC button 52, which is selected, lighting button 53 and alarms button 54. In a data bar 56 are a data bar item 61 showing temperature, and a data item 67 revealing a humidity sensor 66.

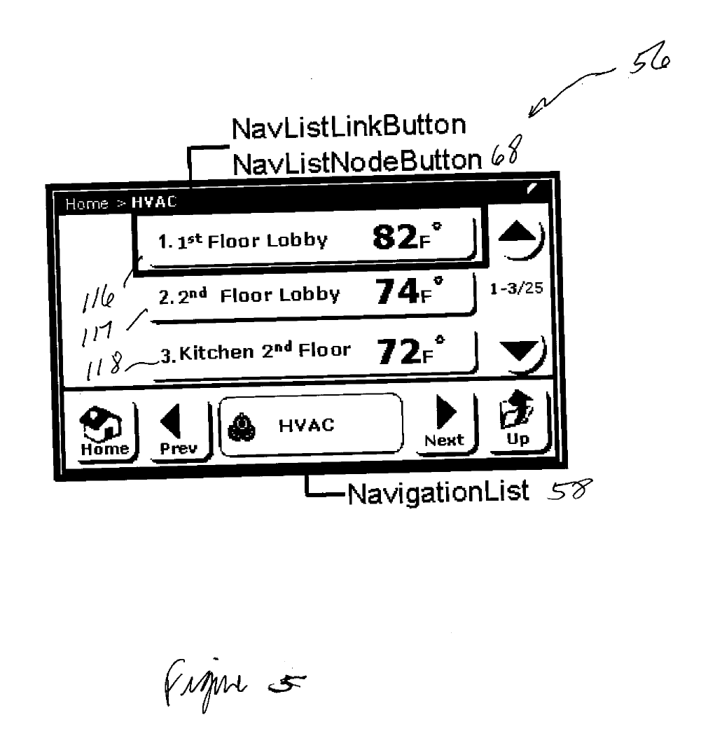

FIG. 5 is a diagram of an HVAC zones 56 screen of navigation list 58 and the nav list node button 68. The zones listed may include a first floor lobby 116 of the first floor 69 and a second floor lobby 117, and a kitchen 118 of the second floor 71.

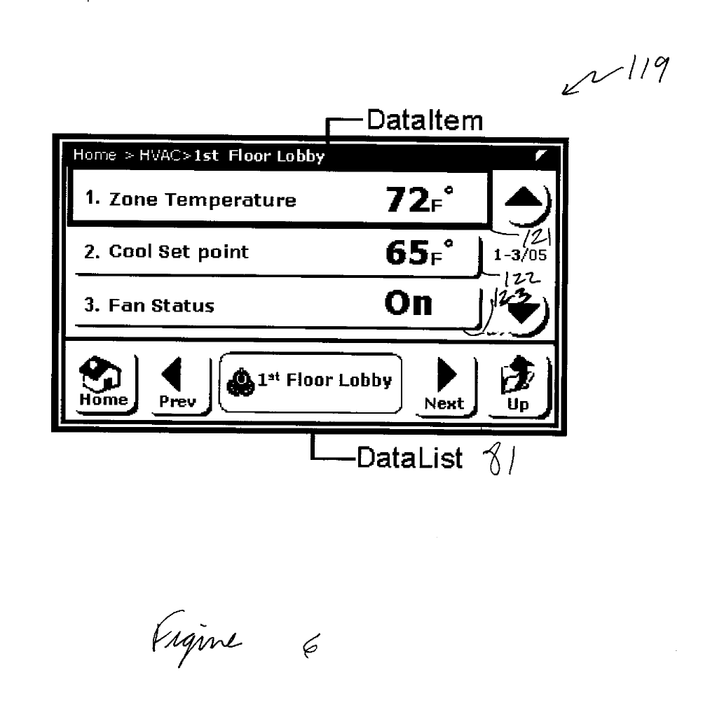

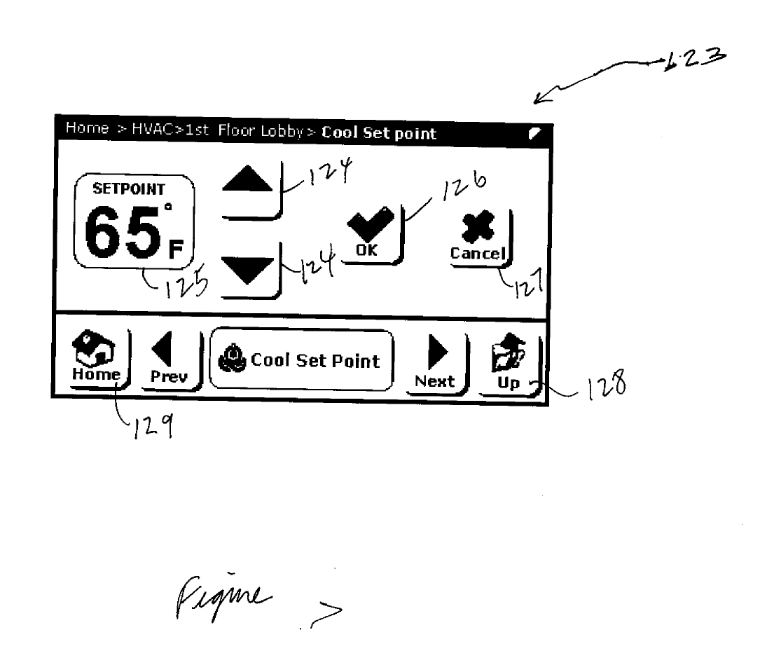

FIG. 6 is a diagram of a screen 119 of a data list 81 and data item 86. For first floor lobby 116, which is selected in screen 56 of FIG. 5, has zone temperature 121, cool setpoint 122, and fan status 123. The selection of cool setpoint 122 may result in a screen showing the cool setpoint 123 in FIG. 7. The setpoint display 125 may be adjusted with up and down buttons 124. If the setting is changed, then one may accept the setpoint by pressing an OK button 126 or reject the change by pressing the cancel button 127. One may return to screen 119 of FIG. 6 by pressing the up button 128 or return to the home screen 51 by pressing a home button 129.

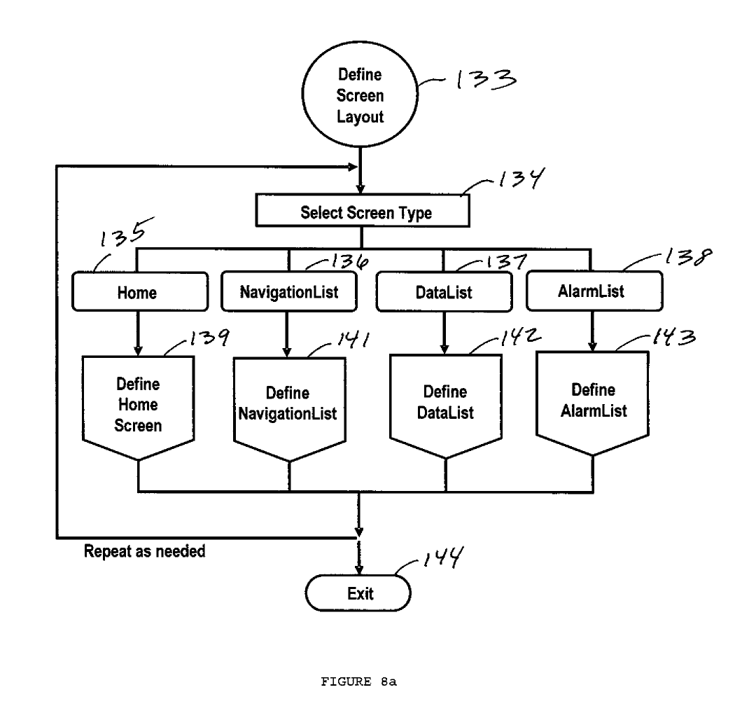

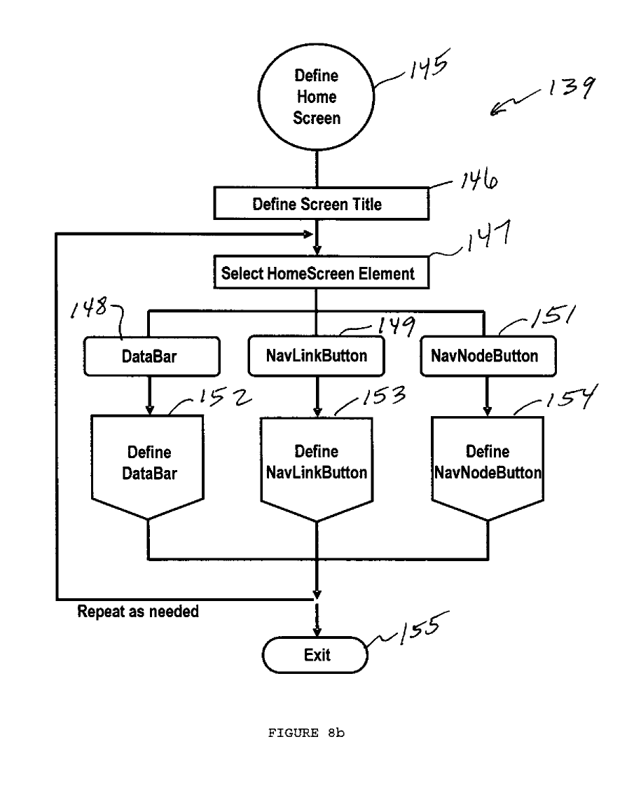

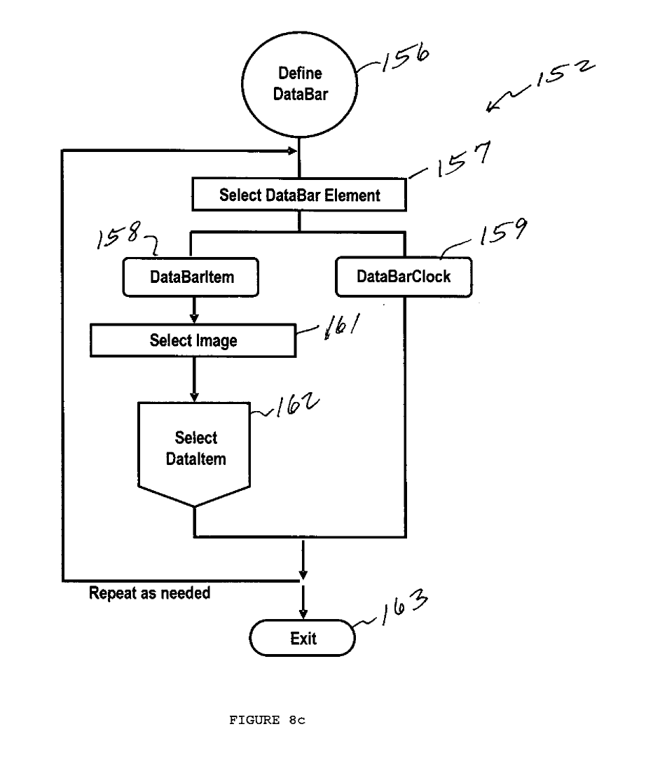

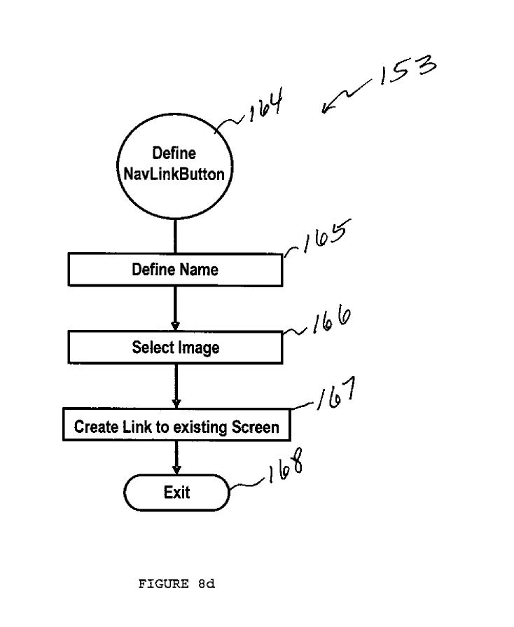

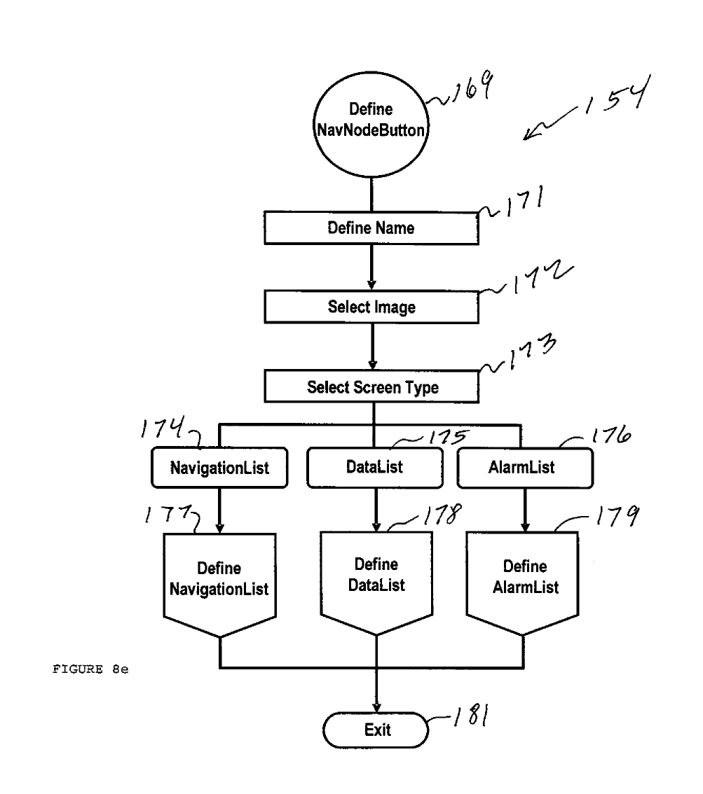

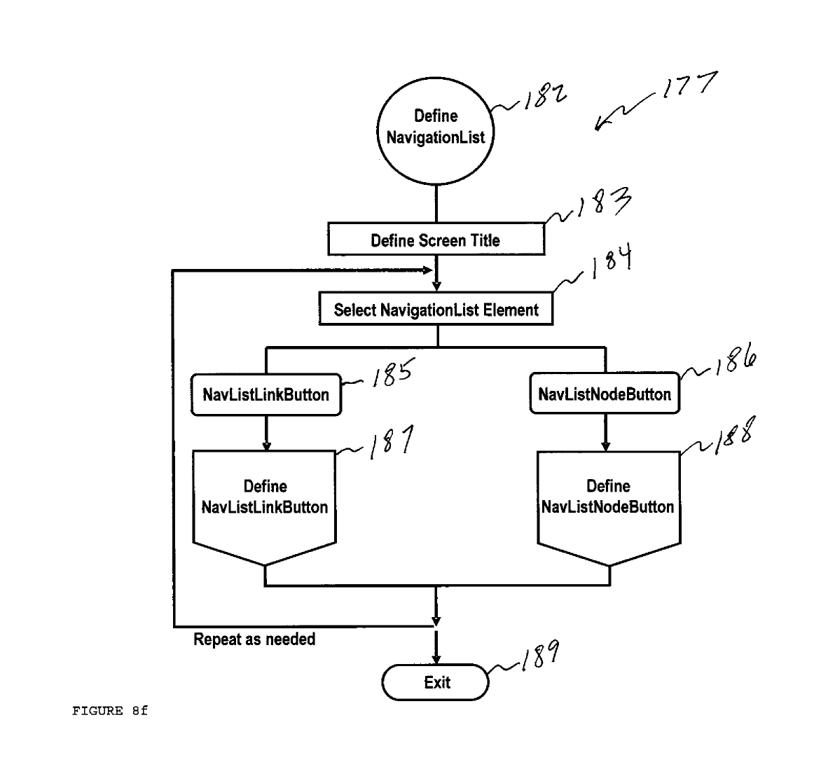

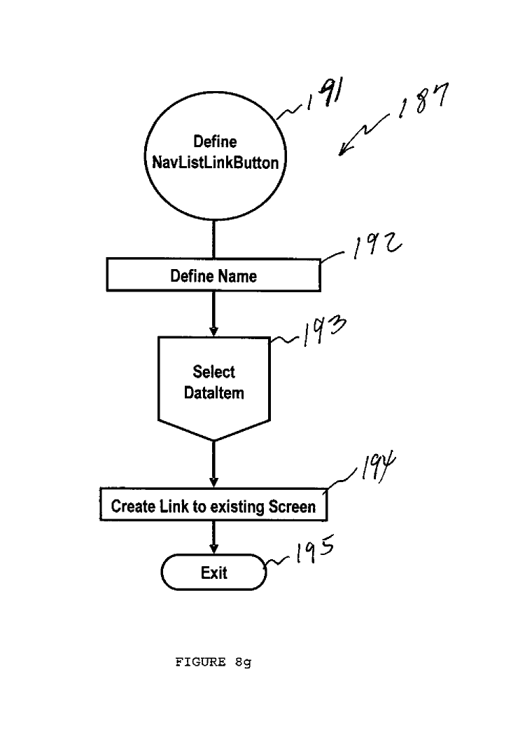

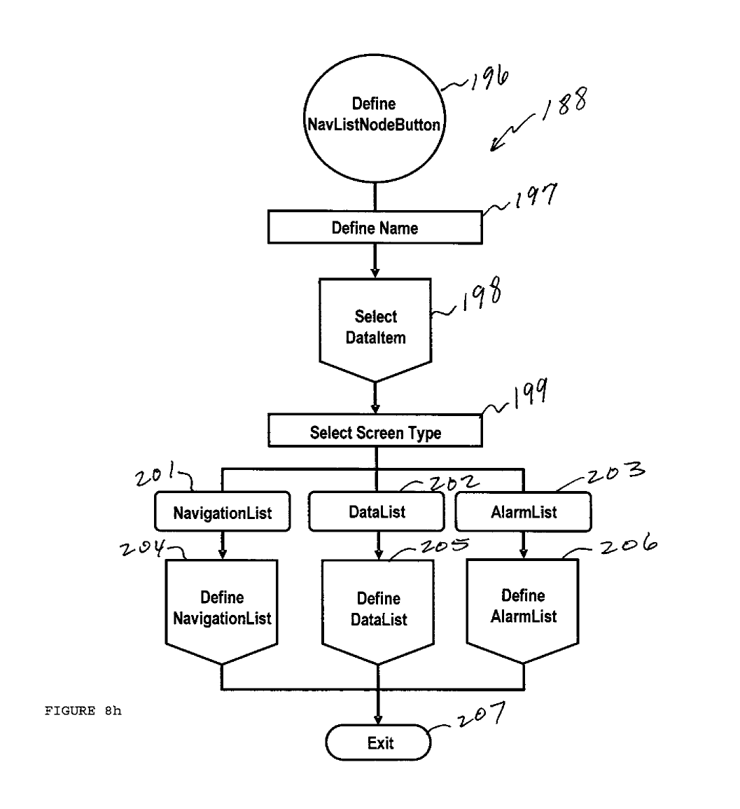

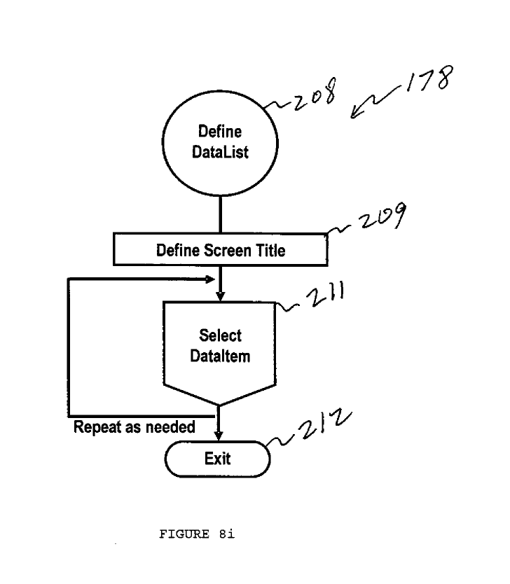

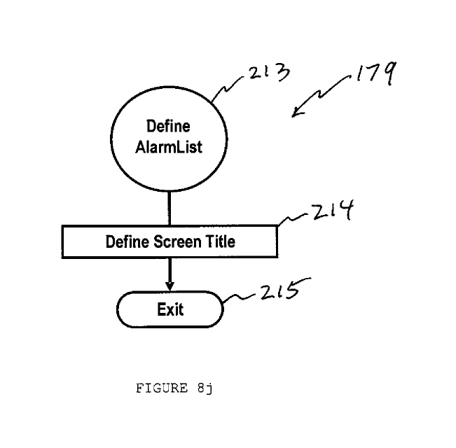

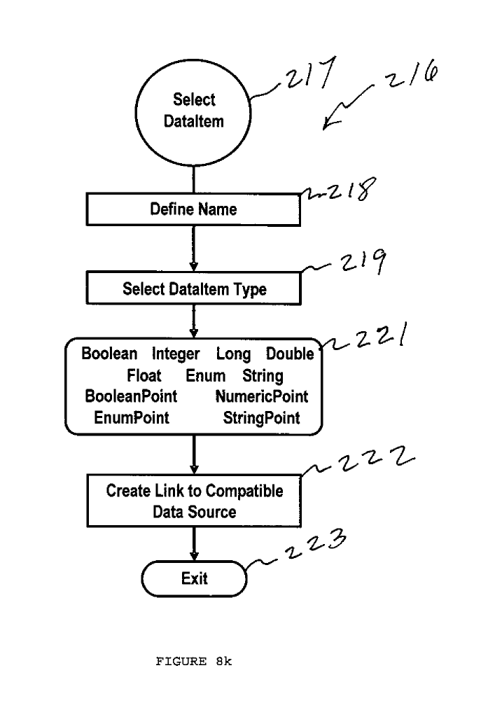

FIG. 8a is an activity diagram of defining a screen layout starting at symbol 133. A screen type may selected at block or step 134 from a group including home 135, navigation list 136, data list 137 and alarm list 138. Having a home 135 selected, the home screen may be defined at symbol 139. Having a navigation list 136 selected, the navigation list may be defined at symbol 141. Having a data list 137 selected, a data list may be defined at symbol 147. Having an alarm list 138 selected, the alarm list may be defined at symbol 143. After symbol 139, 141, 142 or 143, one may repeat the screen type selection at block 134 and go through the process for a selected screen type. Or one may proceed to exit at symbol 144.

FIG. 8b is an activity diagram 139 of defining a home screen starting at symbol 145 and going to defining a screen title at block 146. A home screen element may be selected at step or block 147 from a group including data bar 148, navigation link button 149 and navigation node button 151, which may be defined at symbols 152, 153 and 154, respectively. After a definition of a selected home screen element, one may return to block or step 147 to select another home screen element at block 147, or to exit at symbol 155.

FIG. 8c is an activity diagram 152 of defining a data bar starting at symbol 156, and going to select a data bar element at block 157 from a group including a data bar item 158 and a data bar clock 159. If data bar item is selected, then an image at block 161 may be selected. After block or step 161, a data item may be selected at symbol 162. After symbol 162, one may repeat the process by returning to block 157, for example, to select data bar clock 159, or exit at symbol 163. If data bar clock 159 is selected, then one may go to symbol 157 to repeat the process, or exit at symbol 163.

FIG. 8d is an activity diagram 153 of defining a navigation link button starting at symbol 164, and going to defining a name at block 165, selecting an image at block 166, and creating a link to an existing screen at block 167. Then, one may exit at symbol 168.

FIG. 8e is an activity diagram 154 of defining a navigation node button starting at symbol 169, and going to defining a name at block 171. Then, an image may be selected at block 172 and a screen type may be selected at block 173. The screen type may be selected from a group including a navigation list 174, a data list 175 and an alarm list 176. If the navigation list 174 is selected, then the navigation list may be defined at symbol 177. If the data list 175 is selected, then the data list may be defined at symbol 178. If the alarm list 176 is selected, then the alarm list may be defined at symbol 179. After a definition at symbol 177, 178 or 179, an exit may be made at symbol 181.

FIG. 8f is an activity diagram 177 of defining a navigation list starting at symbol 182, and going to define a screen title at block 183. Then, a navigational list element may be selected at block 184 from a group including a navigational list link button 185 and a navigational list node button 186. The navigational list link button 185 may be defined at symbol 187. The navigational list node button 186 may be defined at symbol 188. After the definition at symbol 187 or 188, one may go to symbol 184 to repeat the process, or to exit at symbol 189.

FIG. 8g is an activity diagram 187 of defining a navigation list link button starting at symbol 191, and going to define a name at block 192. Then, a data item may be selected at symbol 193. After selecting the data item, a link to an existing screen may be created at block 194. Then, one may exit at symbol 195.

FIG. 8h is an activity diagram 188 of defining a navigation list node button starting at symbol 196, and going to define a name at block 197. Then, a data item may be selected at symbol 198; and at block 199, a screen type may be selected from a group including a navigation list 201, data list 202 and alarm list 203. The navigation list, data list and alarm list may be defined at symbols 204, 205 and 206. After a definition at one of these symbols, one may exit at symbol 207.

FIG. 8i is an activity diagram 178 of defining a data list starting at symbol 208, and going to define a screen title at block 209. Then, a data item may be selected at symbol 211. After selecting the data item, one may repeat doing a selection at symbol 211, as needed, and/or exit at symbol 212.

FIG. 8j is an activity diagram 179 of defining an alarm list starting at symbol 213, and going to define a screen title at block 214. Then, one may exit at symbol 215.

FIG. 8k is an activity diagram 216 of selecting a data item starting at a symbol 217, and going to define a name at block 218. Then, a data item type may be selected at block 219 from a group 221 including boolean, integer, long, double, float, enum, string, boolean point, numeric point, enum point, and string point. After selection of a data item type from group 221, a link to a compatible data source may be created at block 222. Then, one may exit at symbol 223.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

1. (canceled)

2. A building automation system comprising:
an HVAC system in communication with and controlled by the building automation system; and
a remote display including a display controller and a dynamically configurable user interface; and
wherein a user of the dynamically configurable user interface may create one or more user interfaces for the building automation system by selecting one or more object types from among a pre-defined set of standardized object types for displaying data related to the building automation system; and
further wherein the display controller is configured and adapted to receive and interpret one or more object types selected by a user from among a pre-defined set of object types, the display controller further configured to display the one or more object types and to display one or more standardized object data types selected by the user within the one or more user interfaces based on a characteristic of the remote display, wherein the standardized object types selected by the user represent components of one or more user interfaces for a display of the building automation system on the remote display, wherein the one or more standardized object types selected by the user define a navigation hierarchy within the one or more user interfaces and wherein each one or more user interfaces has a functionality that defines a look and behavior of the user interface.

3. The building automation system of claim 2, wherein the user interface comprises:
screens;
screen elements;
navigation elements; and
data elements.

4. The building automation system of claim 2, wherein:
an object type comprises a default look and behavior within the display; and
an object type comprises properties for modifying the default look and behavior of the object type.

5. The building automation system of claim 4, wherein screens comprise object types of home object type, navigation list object type, data list and alarm list object type.

6. The building automation system of claim 5, wherein:
the home object type is a home screen;
the home screen is an entry point for the user interface;
the home screen comprises a data bar and one or more buttons;
the one or more buttons comprise a pre-defined ordering mechanism;
the pre-defined ordering mechanism can be modified by an implementation of button positioning properties; and
home screen elements are selected from navigation link button, navigation node button and data bar object types.

7. The building automation system of claim 5, wherein:
the object type of the navigation list is a navigation list screen;
the navigation list screen is for defining a hierarchy of information presented;
the navigation list screen comprises a list of one or more buttons;
the one or more buttons comprise a pre-defined ordering mechanism; and
the one or more buttons of the navigation list screen buttons are selected from navigation list link button and navigation list node button object types.

8. The building automation system of claim 5, wherein:
the object type of the data list is a data list screen;
the data list screen is for displaying a list of one or more data values from a computer;
the one or more data values comprise a pre-defined ordering mechanism; and
the one or more data values are selected from available data item object types.

9. The building automation system of claim 5, wherein:
the object type of the alarm list is an alarm list screen; and
the alarm list screen is for displaying real-time alarm events from a computer.

10. The building automation system of claim 6, wherein:
the navigation link button object type comprises a navigation link button;
the navigation link button can provide a navigable link to a screen object in a user interface hierarchy; and
the navigation link button can display a user-assigned name and a user-selected image.

11. The building automation system of claim 6, wherein:
the navigation node button object type comprises a navigation node button;
the navigation node button can provide a navigable link to a screen object that is a child of the navigation node button; and
the navigation node button can display a user-assigned name and a user-elected image.

12. The building automation system of claim 3, wherein:
the screen elements comprise a data bar;
the data bar has a pre-defined appearance when rendered on the remote display;
a data bar appearance can be modified according to orientation and location;
the data bar comprises a data bar item and data bar clock;
the data bar item comprises a placeholder for a data value;
the data bar item can display a user-assigned name and a user-selected image; and
the data bar clock comprises a placeholder for current time.

13. The building automation system of claim 7, wherein:
the navigation list link button is for defining the hierarchy of information for display, creating a navigable link to a screen object in a user interface hierarchy, and/or being capable of displaying a user-assigned name and a selection from available data item types; and
the navigation list node button is for defining the hierarchy of information for display, creating a navigable link to a screen object which exists as a child of the navigation list node button, and/or being capable of displaying a user-assigned name and a selection from available data item types.

14. A building automation system comprising:
an HVAC system in communication with and controlled by the building automation system; and
a remote display including a display controller and a dynamically configurable user interface; and
wherein the user interface comprises:
screens;
screen elements;
navigation elements; and
data elements and
wherein a user of the dynamically configurable user interface may create one or more user interfaces for the building automation system by selecting one or more object types from among a pre-defined set of standardized object types for displaying data related to the building automation system; and
wherein data items comprise objects which represent primitive data types of a computer.

15. The building automation system of claim 14, wherein:
a data item, when added to a user interface definition, is linked with a compatible data source on a computer;
a data item comprises a predefined behavior so as to adopt modifiers of the compatible data source;
a data item may be an interface for transferring real-time data between a computer and a remote display; and
wherein after the data item is added to a data bar item, a navigation list link button and a navigation list node button allows a value displayed on the data bar item, the navigation list link button and the navigation list node button, to be updated in real time.

16. The building automation system of claim 14, wherein:
when a data item is added to a data list screen, each data item may comprise pre-defined behaviors; and
the pre-defined behaviors comprise:
the data item rendered as a data item button;
a data item interface allows a value displayed on the data item button to be updated in real time;
the data item interface allows a data source to be modified in real time if the data source is in a writeable state;
the data item may be a read only or writeable state of the data source to which the data item has been linked;
if the data source is read only, the data item button has a grayed-out appearance to indicate that a data list entry is inactive and only viewable; and
if the data source is writeable, the data item button has a normal appearance indicating that the data list entry is active and editable.

17. The building automation system of claim 16, wherein the pre-defined behaviors further comprise:
the data item has an associated editing screen; and
wherein:
the editing screen is rendered on the remote display if the data item button is active and pressed; and
if no editing screen is rendered for a data item, a button for that data item appears inactive whether the data source has a read only or writeable state.

18. A method for defining a dynamically configurable user interface of a remote display device for a building automation system in communication with an HVAC system, comprising:
receiving a user selected screen type at the remote display device, the screen type selected from a group comprising a home screen type, navigation list screen type, data list screen type and alarm list screen type;
defining the screen type selected by a user using a standardized set of object types based on one or more characteristics of the remote display device;
rendering and displaying a selected screen type on the remote display device based on the one or more characteristics of the remote display device; and
displaying data associated with an HVAC system controlled by the building automation system on the remote display device.

19. The method of claim 18, further comprising:
selecting the home screen as the screen type; and
defining the home screen; and
wherein defining the home screen comprises:
defining a screen title;
selecting a home screen element from a group comprising a data bar, a navigation link button, and a navigation node button; and
defining the home screen element selected.

20. The method of claim 18, further comprising:
selecting the navigation link button as the home screen element; and
defining the navigation link button; and
wherein defining the navigation link button comprises:
defining a name;
selecting an image; and
creating a link to an existing screen.

21. The method of claim 19, further comprising:
selecting the navigation node button as the home screen element; and
defining the navigation node button; and
wherein defining the navigation node button comprises:
defining a name; and
selecting a screen type from a group comprising a navigation list, a data list and an alarm list.
